(19) United States
(12) Patent Application Publication
(10) Pub. No.: US 2008/0011991 A1
(43) Pub. Date: Jan. 17, 2008

(54) Motorized Trolley

(75) Inventor: Risto Toukola, Statesville, NC (US)

Correspondence Address: CANTOR COLBURN, LLP, 55 GRIFFIN ROAD SOUTH, BLOOMFIELD, CT, 06002, US

(73) Assignee: IPALCO B.V., ALBLASSERDAM BD (NL)

(21) Appl. No.: 11/720,111

(22) PCT Filed: Nov. 18, 2005
(86) PCT No.: PCT/EP05/56072

§ 371 Date: Sep. 26, 2007

(30) Foreign Application Priority Data
Nov. 24, 2004 (LU) 91124

(51) Int. Cl. B66F 19/00

(52) U.S. Cl. 254/264

(57) ABSTRACT

A motorized trolley (10) for suspension from and travel on a rail (12) comprises first and second supporting wheels (14) for location on and engagement with opposite sides of the rail; the first supporting wheel comprising a first shaft (18-1) for rotating the first wheel (14-1) and the second supporting wheel (14-2) comprising a second shaft (18-2) for rotating the second wheel. Driving motors (16) are associated with the shafts for rotating the supporting wheels. Third and fourth supporting wheels may also be driven by motor. The motors are directly connected to the shafts of the supporting wheels.

### TECHNICAL FIELD

The present invention generally relates to a motorized trolley for suspension from and travel on a rail, in particular motorized line trolley for use with a dragline device.

### BACKGROUND ART

Line trolleys generally comprise a chassis having four supporting wheels and a line carrying device for carrying all sorts of cables or hoses connected between a stationary supply point and a moving piece of equipment. The support wheels are arranged so as to engage the rail from opposite sides and travel thereon. Passive line trolleys, i.e. line trolleys without their own drive have the disadvantage of rather abrupt acceleration of the individual trolleys by the previous one. This is damaging to the trolleys themselves and to the connection line therebetween. Furthermore, each time a further trolley is accelerated, the other trolleys are slowed down.

In order to avoid this, motorized line trolleys have been proposed, wherein each line trolley is provided with a driving motor. This enables each trolley to be individually driven and no connection line is necessary between the trolleys for entraining the next trolley. Abrupt accelerations and decelerations of the individual trolleys are thereby avoided. In order for the respective distances between neighboring line trolleys to remain roughly identical throughout the operation range, the line trolleys are preferably driven at decreasing speeds, with the first trolley (i.e. the one extending the furthest away from a rest position) being driven at highest speed and the last trolley (i.e. the one extending the least away from a rest position) being driven at lowest speed. The intermediate trolleys are then driven at appropriate intermediate speeds.

One proposal is to provide the line trolleys with a gearbox drive using a direct current motor which drives the supporting wheels e.g. by means of toothed belts. This solution however has the drawback that a gearbox has to be used in order to reduce the speed of the direct current motor to the speed required to drive the supporting wheels. This gearbox drive method is particularly disadvantageous when it is necessary to drive a plurality of supporting wheels, for example on both sides of the supporting rail, since complicated idler gears and ratios are required in the drive line for this purpose.

Another proposal, as e.g. described in U.S. Pat. No. 5,711,228, is to provide the line trolleys with a synchronous three-phase motor, i.e. a motor which runs at nominal speed and without load practically without current and whose speed can be regulated by a control frequency. By controlling the speed of the individual trolleys through a variation of the frequency delivered to the individual motors, no gearboxes are necessary.

In both proposals, however, the maintenance of the system is relatively high. The gearboxes can jam and the belts can break or be dislodged, in which case, the concerned line trolley is out of action and has to be mended before the dragline device can be used again. Often, the line trolleys are arranged in areas that are difficult to access, which leads to relatively long stoppages and high maintenance costs.

### OBJECT OF THE INVENTION

The object of the present invention is to provide an alternative motorized trolley for suspension from and travel on a rail. This is achieved by a motorized trolley as claimed in claim 1.

### GENERAL DESCRIPTION OF THE INVENTION

According to the invention, a motorized trolley for suspension from and travel on a rail comprises first and second supporting wheels for location on and engagement with opposite sides of the rail; the first supporting wheel comprising a first shaft for rotating the first wheel and the second supporting wheel comprising a second shaft for rotating the second wheel. According to an important aspect of the invention, a first driving motor is associated with the first shaft for rotating the first supporting wheel; and a second driving motor is associated with the second shaft for rotating the second supporting wheel. By providing an individual driving motor for each supporting wheel, the supporting wheels on each side of the rail can be individually driven. In case the rail comprises a corner, the supporting wheel on one side of the rail can be controlled to rotate slightly faster that the supporting wheel on the other side of the wheel as the motorized trolley goes through the corner region. Furthermore, one driving motor can compensate a failure of the other driving motor, so that the motorized trolley can still be moved. A failure of a driving motor does hence not automatically lead to a complete standstill of the motorized trolley and consequently of the dragline device. Maintenance and/or replacement of the faulty driving motor can be carried out at a convenient time, such as a scheduled stoppage of the dragline device. Using motorized trolleys according to the present invention can hence reduce maintenance time and costs.

Advantageously, the first shaft of the first supporting wheel is directly connected to a driving shaft of the first driving motor; and the second shaft of the second supporting wheel is directly connected to a driving shaft of the second driving motor. By directly connecting the shaft of the driving motor to the shaft of the supporting wheel, the driving motor is arranged laterally of the supporting wheel. The motorized trolley can therefore have a more compact height. This is of advantage as the height of the installation is generally more of an issue than the width thereof.

In prior art motorized trolleys, gearboxes or belts are provided between the shaft of the driving motor and the shafts of the supporting wheels. Such gearboxes can be cumbersome and, due to their relatively high number of mechanical parts, prone to jamming or breaking. Belts, although easier in design, can also break or slip off. By directly connecting the shaft of the driving motor to the shaft of the supporting wheel such gearboxes or belts can be avoided, thereby reducing the number of parts and the likelihood of breakages. The number of necessary maintenance interventions can hence be reduced. Furthermore, during such a maintenance intervention, a driving motor or supporting wheel can be more quickly replaced, as no gearbox or belt first has to be disengaged from the old part and then engaged with the new one.

According to a preferred embodiment, the motorized trolley further comprises third and fourth supporting wheels for location on and engagement with opposite sides of the rail; the third supporting wheel comprising a third shaft for rotating the third wheel and the fourth supporting wheel comprising a fourth shaft for rotating the fourth wheel. A third driving motor is then associated with the third shaft for rotating the third supporting wheel; and a fourth driving motor is associated with the fourth shaft for rotating the fourth supporting wheel. By providing the motorized trolley with four supporting wheels, i.e. two on each side of the rail, increased stability of the motorized trolley on the rail is achieved. Furthermore, the failure or malfunctioning of one of the four driving motors can be compensated by the three remaining driving motors.

Preferably, the third shaft of the third supporting wheel is directly connected to a driving shaft of the third driving motor; and the fourth shaft of the fourth supporting wheel is directly connected to a driving shaft of the fourth driving motor.

Advantageously, the shafts of the individual supporting wheels are an extension of the driving shaft of the associated driving motor. The shaft of the driving motor can, for example, be designed so as to directly engage with the supporting wheel so as to capable of directly rotating the latter.

The driving motor, driving shaft and supporting wheel can be designed as a single interchangeable element. Such an interchangeable element can further reduce the duration of a maintenance intervention. A faulty driving motor and/or worn wheel can, during such a maintenance intervention, be quickly replaced by simply removing the interchangeable element in question from the chassis of the motorized trolley and replacing it with a new or repaired one. The interchangeable element removed from the motorized trolley can then be repaired either onsite or even offsite while the dragline device is again in operation. Duration of maintenance interventions and consequently also of maintenance costs can thereby be reduced.

The shafts of the supporting wheels can be arranged in a substantially horizontal plane. Preferably, however, the shafts of the supporting wheels are arranged at a slight angle with respect to the horizontal plane. This allows wheels to be in full contact with an upper surface of the transverse members of the inverted T of the double-T shaped rail. Due to the manufacture of such rails, this upper surface is generally at a slight angle with respect to a horizontal plane. Furthermore, as the angle of the upper surface on either side of the rail is in opposite directions, this arrangement leads to an automatic centering of the motorized trolley with respect to the rail.

The motorized trolley can further comprise adjustment means for adjusting the angle of the shafts with respect to the horizontal plane, whereby albeit is possible to bring the respective shafts into a plane which is parallel to the respective upper surface on which the supporting wheels rest. The motorized trolley can thereby easily be adapted for cooperation with any type of rail.

The motorized trolley can further comprise a control unit for receiving electrical power from an electrical power source and transmitting the electrical power to the driving motors. Such a control unit can be stationary arranged near the electrical power source and control the movement of the individual trolleys. Alternatively, one control unit can be arranged on each motorized trolley and control the movement of the respective trolleys.

The driving motors are preferably three-phase electric motors and the control unit preferably comprises a frequency changer for varying the speed of the driving motors by changing the control frequency. By controlling the frequency of the electric current fed to such driving motors, their speed, and consequently the speed of the motorized trolley, can easily be controlled.

The rail can for example have an inverted-T shaped cross-section or a double-T shaped cross-section.

### BRIEF DESCRIPTION OF THE DRAWINGS

The present invention will now be described, by way of example, with reference to the accompanying drawings, in which

FIG. 1 is a lateral cross-section of a motorized trolley according to the present invention; and

FIG. 2 is a frontal cross-section of the motorized trolley of FIG. 1.

### DETAILED DESCRIPTION OF PREFERRED EMBODIMENTS

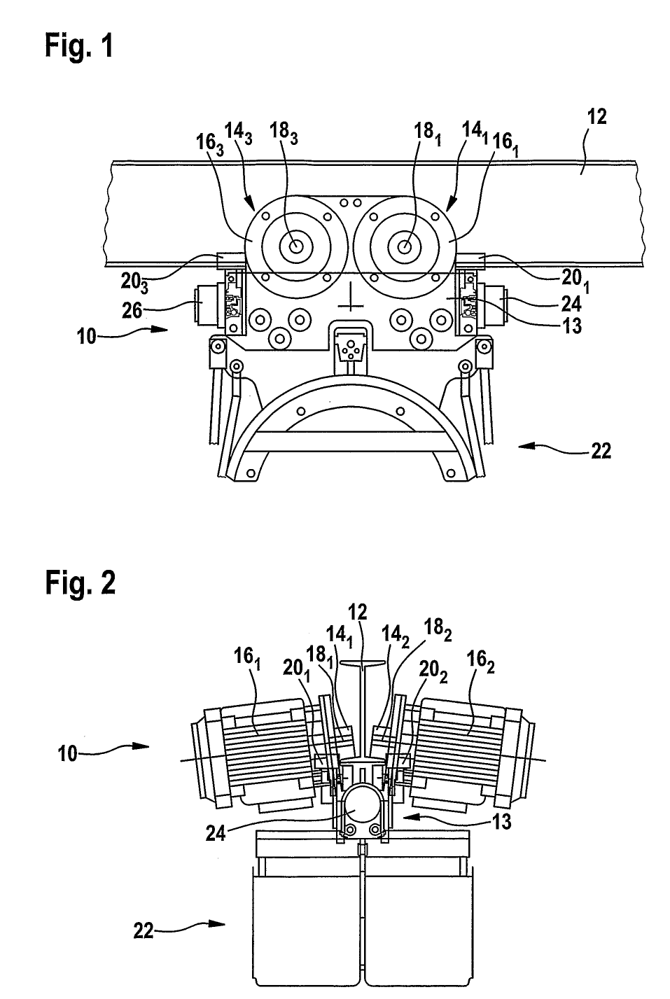

FIGS. 1 and 2 show a motorized trolley 10 for suspension from and travel on a rail 12 with a double-T cross-section, which is best shown in FIG. 2.

The motorized trolley 10 comprises a chassis 13 and is suspended by means of first, second, third and fourth supporting wheels 14₁, 14₂, 14₃, (the fourth supporting wheel cannot be seen in any of the Figures). The supporting wheels 14₁, 14₂, 14₃ run on the inner transverse surfaces of the lower (inverted) T. In each case, two supporting wheels, namely the first and third supporting wheels 14₁, 14₃ and the second and fourth supporting wheels 14₂ are arranged on opposite sides of the rail 12 respectively.

Each supporting wheel 14₁, 14₂, 14₃ has a driving motor 16₁, 16₂, 16₃ associated therewith. Each driving motor 16₁, 16₂, 16₃ comprises a driving shaft 18₁, 18₂, 18₃ which is connected to the associated supporting wheel 14₁, 14₂, 14₃, and which transmits rotational movement from the driving motor 16₁, 16₂, 16₃ to the supporting wheel 14₁, 14₂, 14₃.

The driving motor/driving shaft/supporting wheel assembly, which can be designed as a single interchangeable element, is mounted on the chassis 13. Such an interchangeable element can be particularly advantageous for fast and easy replacement of these parts during a maintenance intervention.

While the supporting wheels 14₁, 14₂, 14₃ have shafts running horizontally, or at a slight angle as shown in FIG. 2, additional guiding wheels 20₁, 20₂, 20₃ associated with each supporting wheel 14₁, 14₂, 14₃ are provided with vertical shafts. The horizontally arranged guiding wheels 20₁, 20₂, 20₃ serve for lateral guidance of the motorized trolley 10 and to this end bear on the ends of the transverse members of the inverted T of the double-T shaped rail 12.

On its underside, the trolley 10 has a line carrying device 22 which takes the form of an essentially semi-circular double-sided support on which to lay lines, hoses, cables and the like, On its front and rear side, viewed in the path of the rail 12, the trolley 10 in each case has a front buffer 24 and an a rear buffer 26 which acts as a damper when two motorized trolleys 10 run into one another or one motorized trolley 10 runs into the wall.

Each of the four driving motors 16₁, 16₂, 16₃ is a synchronous three-phase motor, i.e. a motor which runs at nominal speed and without load practically without current and whose speed can be regulated precisely by the control frequency.

It will be appreciated that, similar to the fourth supporting wheel of the motorized trolley, which cannot be seen in the Figures, the trolley also comprises a driving motor, a driving shaft, a guiding wheel, all associated with the fourth supporting wheel.

A control unit (not shown) is used for receiving electrical power from an electrical power source and for transmitting the electrical power to the driving motors 16₁, 16₂, 16₃. A frequency changer can be provided for controlling the frequency of the electrical power transmitted to the driving motors 16₁, 16₂, 16₃. By controlling the frequency of the electric current fed to the driving motors 16₁, 16₂, 16₃, their speed, and consequently the speed of the motorized trolley 10, can easily be controlled.

In the event of a rise in current due to a reduction in the speed of the motorized trolley 12 and hence the speed of the driving motors 16₁, 16₂, 16₃, the control frequency is adapted to the new speed.

The motorized trolley 10 is operated with a dragline device as follows:

After suspension from the rail 12 and loading of the line carrying device 22 with lines, cable and hoses (not shown) and connection of the driving motors 16₁, 16₂, 16₃, the dragline device is ready for operation. As a rule, a plurality of motorized trolleys 10 are arranged on a rail 12 one behind another, for example as on an assembly line rail in a production plant or a rail arrangement for the traveling carriage of a crane. When the end user attached to the rail, i.e. the traveling carriage for example, is to be moved, the driving motors 16₁, 16₂, 16₃ of each trolley 10, are activated. For this, preferably the frequency is slowly ramped up and the speed continuously increased. A plurality of trolleys 10 are activated with different frequencies by a common circuit, the motorized trolleys 10 next to the traveling carriage being activated with the highest frequency and the motorized trolley 10 furthest back with the lowest frequency. This corresponds to the different optimum speeds of the motorized trolleys 10 when the traveling carriage is moving. It will be appreciated that, generally for cost reasons, it is possible to provide a dragline device with a plurality of trolleys, only some of which are motorized.

1. A motorized trolley for suspension from and travel on a rail comprising:
first and second supporting wheels for location on and engagement with opposite sides of the rail; said first supporting wheel comprising a first shaft for rotating said first wheel and said second supporting wheel comprising a second shaft for rotating said second wheel;
characterized in that
a first driving motor is associated with said first shaft for rotating said first supporting wheel; and
a second driving motor is associated with said second shaft for rotating said second supporting wheel.

2. The motorized trolley according to claim 1, wherein
said first shaft of said first supporting wheel is directly connected to a driving shaft of said first driving motor; and
said second shaft of said second supporting wheel is directly connected to a driving shaft of said second driving motor.

3. The motorized trolley according to claim 1 or 2, further comprising:
third and fourth supporting wheels for location on and engagement with opposite sides of the rail; said third supporting wheel comprising a third shaft for rotating said third wheel and said fourth supporting wheel comprising a fourth shaft for rotating said fourth wheel;
a third driving motor associated with said third shaft for rotating said third supporting wheel; and
a fourth driving motor is associated with said fourth shaft for rotating said fourth supporting wheel.

4. The motorized trolley according to claim 3, wherein
said third shaft of said third supporting wheel is directly connected to a driving shaft of said third driving motor; and
said fourth shaft of said fourth supporting wheel is directly connected to a driving shaft of said fourth driving motor.

5. The motorized trolley according to any of the previous claims, wherein the shafts of the individual supporting wheels are an extension of the driving shaft of the associated driving motor.

6. The motorized trolley according to claim 5, wherein each driving motor forms, with its associated driving shaft and its associated supporting wheel, an interchangeable element.

7. The motorized trolley according to any of the previous claims, wherein said shafts of said supporting wheels are arranged at a slight angle with respect to a horizontal plane.

8. The motorized trolley according to claim 7, further comprising adjustment means for adjusting said angle of said shafts with respect to said horizontal plane.

9. The motorized trolley according to any of the previous claims, further comprising a control unit, said control unit receiving electrical power from an electrical power source and transmitting said electrical power to said driving motors.

10. The motorized trolley according to claim 9, wherein said driving motors are three-phase electric motors and wherein said control unit comprises a frequency changer for varying the speed of the driving motors by changing the control frequency.

11. The motorized trolley according to any of the previous claims, wherein said rail has an inverted-T shaped cross-section.

12. The motorized trolley according to any of the previous claims, wherein said rail has a double-T shaped cross-section.
